(19) United States
(12) Patent Application Publication
(10) Pub. No.: US 2024/0198830 A1
(43) Pub. Date: Jun. 20, 2024

(54) CHARGING SYSTEM, MOVABLE ENERGY STORAGE DEVICE AND CHARGING METHOD OF ELECTRIC VEHICLE

(71) Applicant: INDUSTRIAL TECHNOLOGY RESEARCH INSTITUTE, Hsinchu (TW)

(72) Inventors: Ming-Tsan PENG, Taoyuan City (TW); Chia-Lin WU, Kaohsiung City (TW); Kao-Hone CHU, Kaohsiung City (TW)

(73) Assignee: INDUSTRIAL TECHNOLOGY RESEARCH INSTITUTE, Hsinchu (TW)

(21) Appl. No.: 18/083,257

(22) Filed: Dec. 16, 2022

(51) Int. Cl. B60L 53/35; B60L 53/56; B60L 53/66; H02J 7/00

(52) U.S. Cl. CPC B60L 53/35; B60L 53/56; B60L 53/66; H02J 7/0044; H02J 7/0071; H02J 7/00712; H02J 2207/20

(57) ABSTRACT

A charging system, configured to charge an electric vehicle, includes a plurality of movable energy storage devices and an operation center. Each movable energy storage device includes a carrier, a dynamic balancer disposed on the carrier, and an energy storage set including two flywheel energy storage modules disposed on the dynamic balancer and dynamically balanced relative to the carrier through the dynamic balancer. The operation center includes a charging station and a controller which is in communication connection with the movable energy storage devices. The controller is configured for instructing at least one movable energy storage device to move to the charging station for the charging station to charge the at least one energy storage set, or the controller is configured for instructing at least one movable energy storage device to move to the electric vehicle for the at least one energy storage set to charge the electric vehicle.

### TECHNICAL FIELD

The present disclosure relates to a charging system, a movable energy storage device, and a charging method, more particularly to a charging system, a movable energy storage device and a charging method for one or more electric vehicle.

### BACKGROUND

The green energy industry is popular than ever, and developing electrically-powered transport or vehicles such as electric cars for gradually reducing the usage of fuel vehicles has become a topic issue in the green energy industry.

In order to provide charging service for the growing number of electric vehicles, charging equipment needs to be installed in more parking areas. The charging equipment mostly needs to be disposed near the parking space for charging the electric car in the parking space through electric wires arranged under the floor or in the walls therebetween. However, not every parking space is convenient for wiring. High difficulty in wiring and high cost may occur in installing the charging equipment in parking area. The current installation growth rate of charging equipment in the parking space cannot easily catch up the sales growth rate of electric cars, causing inconvenient in charging electric cars due to the insufficient quantity of charging equipment.

### SUMMARY

The present disclosure provides a charging system, a movable energy storage device, and a charging method which are capable of solving the problem of difficulty in wiring and high cost of installing charging equipment in parking area, where the charging system, the movable energy storage device, and the charging method are adapted for electrically-powered vehicles regardless for transporting people or cargo or travelling by land, sea, or air.

According to one aspect of the present disclosure, a charging system configured to charge an electric vehicle includes a plurality of movable energy storage devices and an operation center. Each movable energy storage device includes a carrier, a dynamic balancer disposed on the carrier, and at least one energy storage set including two flywheel energy storage modules disposed on the dynamic balancer and dynamically balanced with respect to the carrier through the dynamic balancer. The operation center includes a charging station and a controller which is in communication connection with the plurality of movable energy storage devices. The controller is configured for instructing at least one of the plurality of movable energy storage devices to move to the charging station for the charging station to charge the at least one energy storage set, or the controller is configured for instructing at least one of the plurality of movable energy storage devices to move to the electric vehicle for the at least one energy storage set to charge the electric vehicle.

According to another aspect of the present disclosure, a movable energy storage device includes a carrier, a dynamic balancer disposed on the carrier, and at least one energy storage set including two flywheel energy storage modules disposed on the dynamic balancer and dynamically balanced with respect to the carrier through the dynamic balancer.

According to further another aspect of the present disclosure, a charging method of an electric vehicle includes the following steps: sending a charging request to a controller of an operation center by an electric vehicle, wherein the charging request comprises a charging requirement of the electric vehicle; and sending a dispatch instruct to at least one movable energy storage device by the controller according to the charging request so that the at least one movable energy storage device moves to the electric vehicle and charges the electric vehicle, wherein the dispatch instruct comprises the charging requirement.

According to the charging system, the movable energy storage device, and the charging method discussed above, with the movable energy storage devices capable of transferring electricity between the charging station and the electric vehicle, the electric vehicle can be charged without wiring to the charging station of the operation center, thereby solving the problem of difficulty in wiring and high cost of installing charging equipment in parking area.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a block diagram of a charging system according to one embodiment of the present disclosure;

FIG. 2 is a perspective view of a movable energy storage device of the charging system in FIG. 1;

FIG. 3 is a perspective view of partial components of the movable energy storage device in FIG. 2;

FIG. 4 is a flow chart showing the operation of the charging system in FIG. 1;

FIG. 5 to FIG. 6 are schematic views showing the deflection of the movable energy storage device in FIG. 2; and

FIG. 7 is a block diagram of a charging system according to another embodiment of the present disclosure.

### DETAILED DESCRIPTION

Aspects and advantages of the invention will become apparent from the following detailed descriptions with the accompanying drawings. For purposes of explanation, one or more specific embodiments are given to provide a thorough understanding of the invention, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

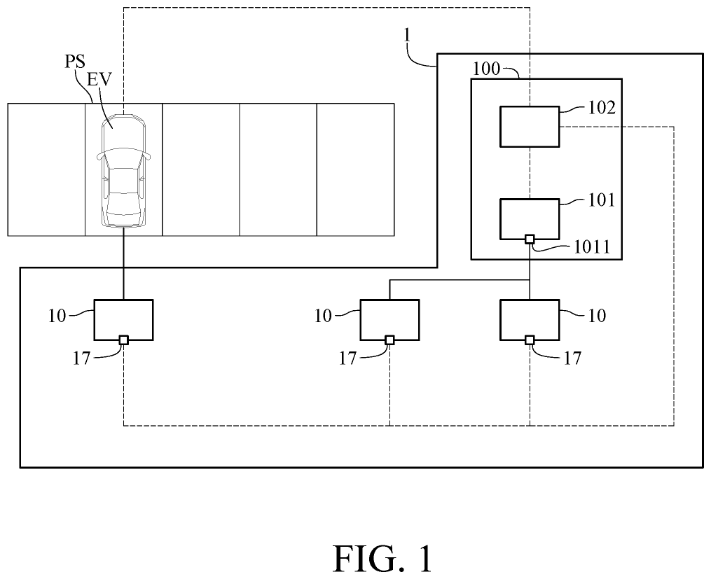

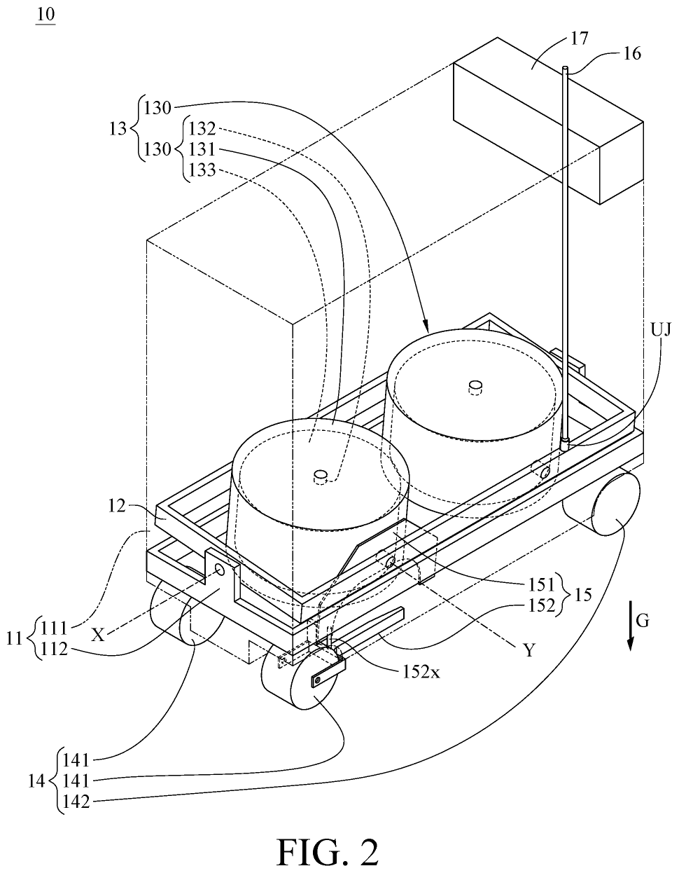

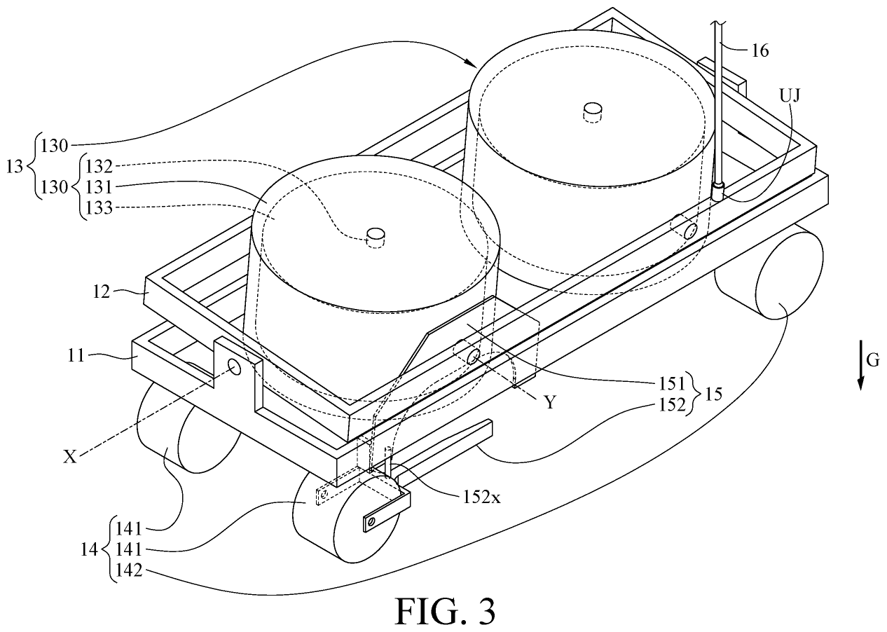

Please refer to FIG. 1 to FIG. 3, where FIG. 1 is a block diagram of a charging system according to one embodiment of the present disclosure, FIG. 2 is a perspective view of a movable energy storage device of the charging system in FIG. 1, and FIG. 3 is a perspective view of partial components of the movable energy storage device in FIG. 2.

One embodiment of the present disclosure provides a charging system 1. As shown in FIG. 1, the charging system 1 may be applied in, for example, a parking area. The charging system 1 includes a plurality of movable energy storage devices 10 and an operation center 100. The movable energy storage devices 10 may be movable and able to store electricity. Thus, the movable energy storage devices 10 may be distributed to the selected areas (e.g., the parking space PS) in the parking area. The operation center 100 is provided to arrange the specific distribution of the movable energy storage devices 10, and the operation center 100 is also able to instruct the specific movable energy storage device 10 to charge an electric car (e.g., an electric vehicle EV) which is parked in the respective parking space PS. Please see the following for the detail.

An exemplary configuration of the movable energy storage device 10 is depicted in FIG. 2 and FIG. 3. As shown, the movable energy storage device 10 may include a carrier 11, a dynamic balancer 12, an energy storage set 13, a plurality of wheels 14, a deflection assembly 15, a handle 16, and a processing module 17. The operation center 100 includes a charging station 101 and a controller 102.

The carrier 11 includes a housing 111 and a frame structure 112. The frame structure 112 is disposed in the housing 111.

The dynamic balancer 12 is pivotably connected to the frame structure 112 of the carrier 11 and pivotable about a first axis X. The first axis X may be substantially in parallel with the ground when the movable energy storage device 10 is in used.

The energy storage set 13 includes two flywheel energy storage modules 130. Each flywheel energy storage module 130 includes a casing 131, a shaft 132, and a flywheel 133, the casing 131 is pivotably connected to the dynamic balancer 12 and pivotable about a second axis Y. The second axis Y is perpendicular to the first axis X. The shaft 132 is disposed in the casing 131. The shaft 132 extends in a direction perpendicular to the second axis Y. The flywheel 133 is disposed on the shaft 132 and therefore is rotatable in the casing 131 by taking the shaft 132 as a rotation axis.

The flywheel energy storage modules 130 are able to store rotational energy (mechanical energy) created by the flywheels 133, and the rotational energy can be converted into electricity. The faster the flywheel 133 rotates, the more the energy the flywheel energy storage module 130 creates; in other words, the flywheel energy storage module 130 uses kinetic energy as a form of storage, and the faster and heavier the flywheel 133, the more energy it can produce. In some embodiments, the flywheel energy storage module 130 may store energy for 10 minutes to 3 hours. In some embodiments, the energy density produced by the flywheels 133 may reach 50 to 100 Wh/kg. In the case that the total weight of the flywheels 133 of the energy storage set 13 is 100 kg, the energy stored in the energy storage set 13 may be converted to electricity of about 5 to 10 kWh.

The flywheels 133 of the flywheel energy storage modules 130 may rotate in opposite directions while having the same absolute value of angular velocity and the same absolute value of angular acceleration. In this case, the sum of the angular velocities of the flywheels 133 of the energy storage set 13 is zero, and the sum of the angular accelerations of the flywheels 133 of the energy storage set 13 is zero. Accordingly, the torques generated by the flywheels 133 may against each other and therefore the flywheel energy storage modules 130 are prevented from affecting the dynamic balancer 12. Also, during the rotation of the flywheels 133, the shaft 132 remains perpendicular to the first axis X (i.e., perpendicular to the ground), such that the dynamic balancer 12 remains balanced with respect to the frame structure 112, and the flywheel energy storage modules 130 are dynamically balanced with respect to the carrier 11 through the dynamic balancer 12.

Please refer to FIG. 2 and FIG. 3, in this embodiment, the wheels 14 include two deflection wheels 141 and two driven wheels 142. The deflection wheels 141 and the driven wheels 142 are arranged under the housing 111 of the carrier 11. The deflection wheels 141 are rotatably located adjacent to a side of the carrier 11 while the driven wheels 142 are rotatably located adjacent to an opposite side of the carrier 11. The wheels 14 enables the movement of the carrier 11 and the deflection wheels 141 allow the carrier 11 to change direction.

As shown in FIG. 2 and FIG. 3, in this embodiment, the deflection assembly 15 includes a first deflection member 151 and a second deflection member 152. The first deflection member 151 is fixed on the casing 131 of one of the flywheel energy storage modules 130 and is rotatably connected to the dynamic balancer 12. The second deflection member 152 is rotatably disposed under the housing 111 about a rotation axis 152x, and one of the deflection wheels 141 is rotatably disposed on the second deflection member 152. The rotation of the first deflection member 151 can drive the second deflection member 152 to rotate so as to deflect one of the deflection wheels 141. The other deflection wheel 141 can be rotated by the similar manner.

The handle 16 has one end disposed through the housing 111 and the other end coupled to the dynamic balancer 12 through, for example, a universal joint UJ. By operating the handle 16, the dynamic balancer 12 can be moved with respect to the frame structure 112 of the carrier 11.

The processing module 17 is disposed in the housing 111. The processing module 17 is able to be in communication connection with the controller 102 of the operation center 100.

In one embodiment, the charging station 101 may be electrically connected to the mains electricity. The charging station 101 may have a power converter 1011. The energy storage sets 13 of the movable energy storage devices 10 may obtain mains electricity via the power converter 1011. The providing of the mains electricity is favorable for increasing the rotational speed of the flywheels 133 and therefore can increase the energy stored in the energy storage sets 13.

The controller 102 is able to instruct the processing module 17 to activate the wheels 14 so as to move the movable energy storage device 10 to the charging station 101 for obtaining electricity. The controller 102 may also instruct the movable energy storage device 10 to move to the selected electric vehicle EV for charging the electric vehicle EV.

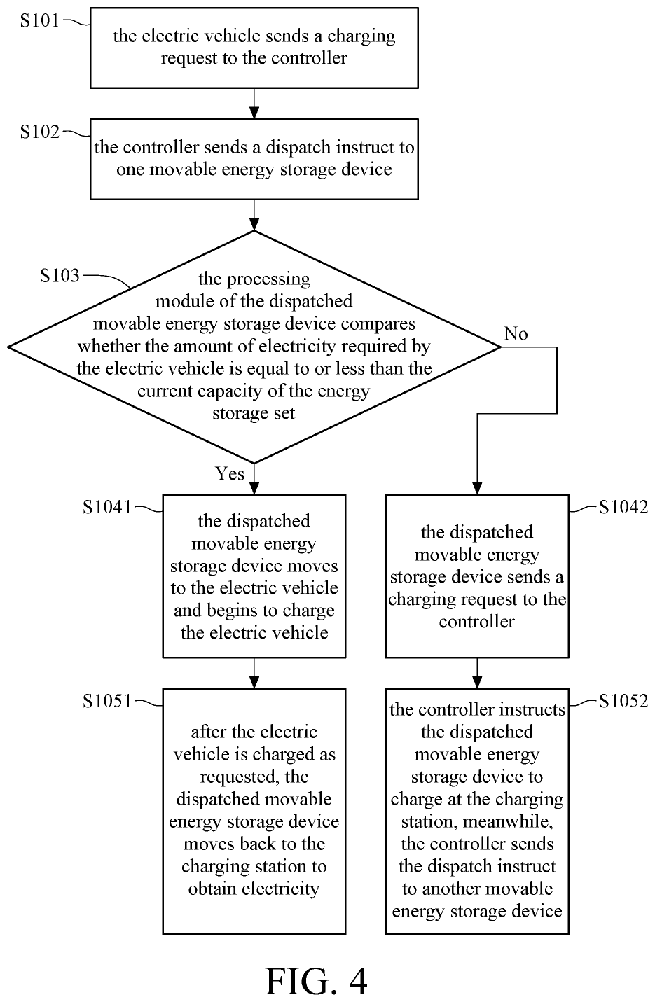

Please further refer to FIG. 4, where FIG. 4 is a flow chart showing the operation of the charging system in FIG. 1. In step S101, the electric vehicle EV in a parking space PS is able to send a charging request to the controller 102 through any suitable communication manner. The charging request may include the location of the selected parking space PS, the information relevant to the charging requirements (e.g., charging power and the required charging capacity), and the pick-up time.

In step S102, the controller 102 outputs a time point for charging according to the received charging request, and the controller 102 sends a dispatch instruct to one of the movable energy storage devices 10 and put the selected movable energy storage device 10 on a charging schedule. The dispatch instruct may, but is not limited to, include the time point for charging, the location of the selected parking space PS, the information relevant to the charging requirements (e.g., charging power and the required charging capacity), and the pick-up time. Note that the pick-up time may be optional; in some other embodiments, the charging request may not include pick-up time. It is also noted that the time point for charging may be obtained by considering the charging schedules of the movable energy storage devices 10.

In step S103, the processing module 17 of the dispatched movable energy storage device 10 compares whether the amount of electricity required by the electric vehicle EV is equal to or less than the current capacity of the energy storage set 13.

When a comparison result determined by the processing module 17 is that the current capacity of the energy storage set 13 is equal to or more than the electricity required by the electric vehicle EV, the dispatched movable energy storage device 10 is determined to be able to complete the dispatch task. Then, step S1041 is performed. In step S1041, the dispatched movable energy storage device 10 moves to the electric vehicle EV and begins to charge the electric vehicle EV at the time point for charging. In step S1051, after the electric vehicle EV is charged as requested, the dispatched movable energy storage device 10 moves back to the charging station 101 to obtain electricity based on the charging schedule. Please be noted that the time point for charging is optional and not intended to limit the present disclosure. In some other embodiments of the present disclosure, the dispatch instruct may not include the time point for charging.

On the other hand, when a comparison result determined by the processing module 17 is that the current capacity of the energy storage set 13 is lesser than the electricity required by the electric vehicle EV, the dispatched movable energy storage device 10 is determined to be unable to complete the dispatch task. Then, step S1042 is performed. In step S1042, the dispatched movable energy storage device 10 sends a charging request to the controller 102. Then, in step S1052, the controller 102 reschedules the dispatched movable energy storage device 10 and instructs the dispatched movable energy storage device 10 to charge at the charging station 101, meanwhile, the controller 102 may send the dispatch instruct to another movable energy storage device 10.

When the movable energy storage device 10 is moving, the processing module 17 thereof may transmit the current location and speed of the carrier 11 to the controller 102 every specific time period (e.g., 10 seconds), allowing the controller 102 to determine whether to transmit a deflection instruction to the processing module 17. When the processing module 17 receives the deflection instruction, the processing module 17 instructs the deflection wheels 141 to turn to a direction as required and thereby timely redirecting the movable energy storage device 10 and ensuring that the movable energy storage device 10 is on a predetermined route.

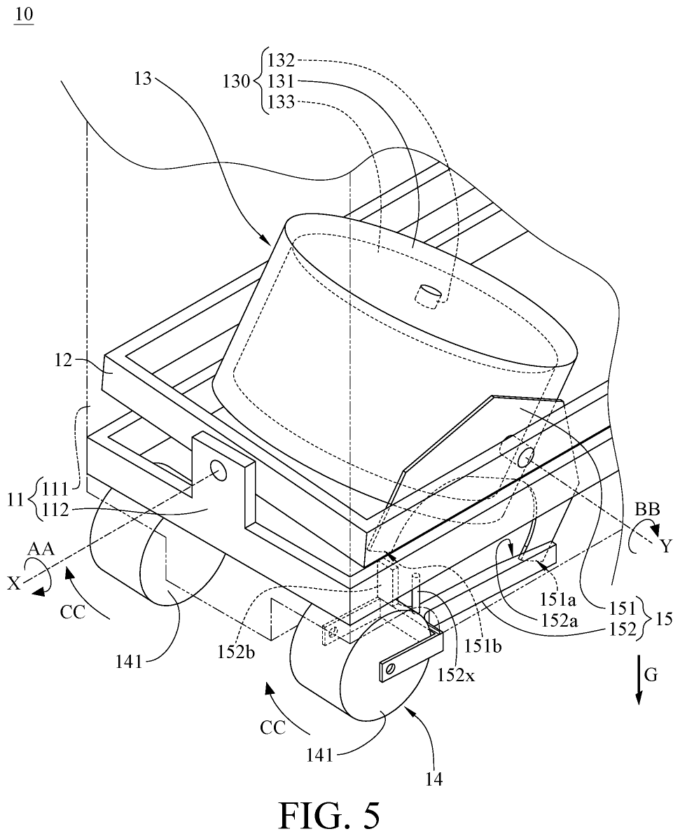

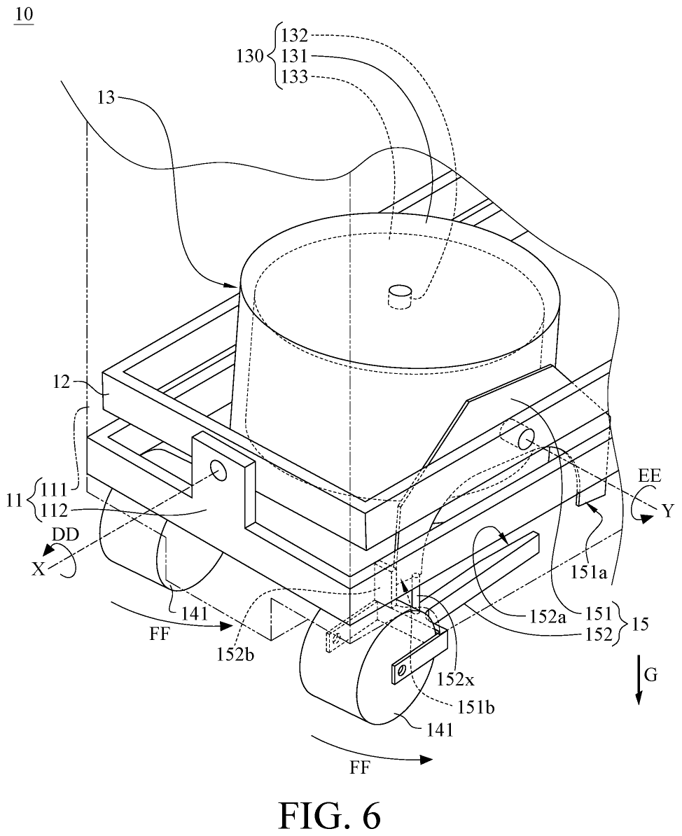

For example, please refer to FIG. 2, FIG. 3, FIG. 5 and FIG. 6, when the processing module 17 receives the deflection instruction to make a right turn, the handle 16 is moved downwards along the gravity direction G to cause the dynamic balancer 12 to pivot in a direction AA about the first axis X with respect to the frame structure 112, as shown in FIG. 5. By doing so, the dynamic balancer 12 and the energy storage set 13 thereon are inclined with respect to the frame structure 112. Meanwhile, due to the gyroscope effect of the flywheels 133, one of the flywheel energy storage modules 130 will pivot in a direction BB about the second axis Y with respect to the dynamic balancer 12 and thereby causing the first deflection member 151 of the deflection assembly 15 to pivot in the direction BB with respect to the dynamic balancer 12 until a rear end 151a of the first deflection member 151 pushes a rear end 152a of the second deflection member 152. The second deflection member 152 has an inclined surface at its rear end 152a. The push of the rear end 151a to the inclined surface of the rear end 152a will force the second deflection member 152 and the deflection wheel 141 connected thereto to pivot in a direction CC. And this will also cause the other deflection wheel 141 pivot in the direction CC. As a result, the deflection wheels 141 are pivoted to the same direction and thereby changing the direction that the movable energy storage device 10 travels (e.g., a right turn).

When the movable energy storage device 10 is redirected as required, the handle 16 is moved upwards so as to return the dynamic balancer 12 back to its original position. Similarly, please refer to FIG. 2, FIG. 3 and FIG. 6, when the processing module 17 receives the deflection instruction to make a left turn, the handle 16 is moved upwards along a direction opposite to the gravity direction G to cause the dynamic balancer 12 to pivot in a direction DD about the first axis X with respect to the frame structure 112, as shown in FIG. 6. By doing so, the dynamic balancer 12 and the energy storage set 13 thereon are inclined with respect to the frame structure 112. Meanwhile, due to the gyroscope effect of the flywheels 133, one of the flywheel energy storage modules 130 will pivot in a direction EE about the second axis Y with respect to the dynamic balancer 12 and thereby causing the first deflection member 151 of the deflection assembly 15 to pivot in the direction EE with respect to the dynamic balancer 12 until a front end 151b of the first deflection member 151 pushes a front end 152b of the second deflection member 152. The second deflection member 152 may also have an inclined surface at its front end 152b similar to that at the rear end 151a for forcing the second deflection member 152 and the deflection wheel 141 connected thereto to pivot along a direction FF. And this will also cause the other deflection wheel 141 pivot in the direction FF. As a result, the deflection wheels 141 are pivoted to the same direction and thereby changing the direction that the movable energy storage device 10 travels (e.g., a left turn).

Please be noted that in some other embodiments of the present disclosure, the handle may be driven by an actuator (e.g., a hydraulic cylinder), and the processing module may instruct the actuator to apply a driving force to move the handle. In further some other embodiments of the present disclosure, the handle may be driven manually. The present disclosure is not limited thereto.

According to the charging system 1 discussed above, with the movable energy storage devices 10 capable of transferring electricity between the charging station 101 and the electric vehicle EV, the electric vehicle EV in the parking space PS can be charged without wiring to the charging station 101 of the operation center 100.

In some other embodiments, the movable energy storage device may have a charging connector for transferring electricity with the charging station or with the electric vehicle. In some other embodiments, there may be an additional charging connector configured to be connected between the movable energy storage device and the charging station or between the movable energy storage device and the electric vehicle. The present disclosure is not limited thereto.

In some other embodiments, the quantity of the deflection assembly may be two, and the deflection assemblies are respectively connected to the two deflection wheels. The present disclosure is not limited thereto. Alternatively, in some other embodiments, the wheels may include four deflection wheels, and the present disclosure is not limited thereto.

In some other embodiments of the present disclosure, there may be a track laid on the predetermined route of the movable energy storage device, allowing the movable energy storage device able to move on the track through any suitable wheels or directly slide on the track.

In some other embodiments, the movable energy storage device may be manually driven to move between the charging station and the electric vehicle to save electricity of the movable energy storage device required for transmitting the current location and speed to the controller.

In some other embodiments, the processing module may consider the movement energy consumption required for the movable energy storage device to move between the charging station and the electric vehicle when comparing the charging requirement of the electric vehicle and the current capacity of the energy storage set, unless there is a spare battery disposed in the movable energy storage device for the movement energy consumption.

In some other embodiments, the quantity of the energy storage set in each movable energy storage device may be plural. It can be considered that the total quantity of the flywheel energy storage modules in each movable energy storage device may be an even number of four or more. Also, each energy storage set may further include a plurality of covering members. The quantity of the covering members is the same as the total quantity of the flywheel energy storage modules. The covering members may be cylindrical and respectively cover the flywheel energy storage modules, such that the covering members are easily to be stacked, and the flywheel energy storage modules in the covering members may be arranged in series or in parallel based on the actual requirements.

In some other embodiments, the charging station may further include energy storage battery whose charging power for obtaining electricity from the mains electricity is lower than the charging power of the flywheel energy storage module for charging a commercially available common electric vehicle. Therefore, the energy storage battery of the charging station can be used to store energy for a relatively long time, and the flywheel energy storage module can be used to complete the charging dispatch task in a relatively short time with a relatively high charging power.

In some other embodiments, the controller may send the dispatch instruct to a plurality of movable energy storage devices at the same time, so that the movable energy storage devices can alternately move between the charging station and the electric vehicle for quickly charging the electric vehicle through the high charging power of the flywheel energy storage modules.

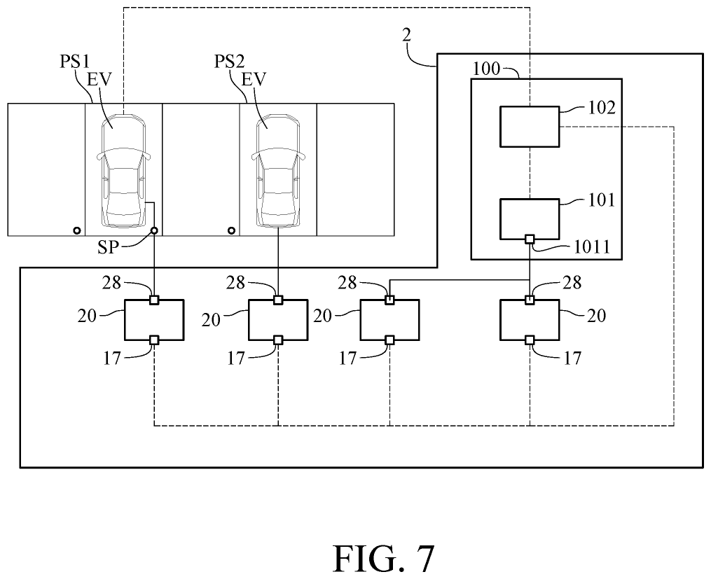

Please be noted that the charging system 1 in the abovementioned embodiment is exemplary but not intended to limit the disclosure. Please refer to FIG. 7, which is a block diagram of a charging system according to another embodiment of the present disclosure. For simplicity, only the differences between a charging system 2 in this embodiment and the charging system 1 in the previous embodiments, as well as the necessary element, will be illustrated hereinafter.

As shown in FIG. 7, the charging system 2 is adapted for a parking area with energy storage type charging piles SP. The energy storage type charging piles SP are able to store electricity. The charging system 2 may directly provide electricity for the energy storage type charging piles SP, and the energy storage type charging piles SP can further provide electricity for the electric vehicle EV. It can be considered that the charging system 2 indirectly charging the electric vehicle EV in the parking space PS1.

The movable energy storage device 20 may further include an inverter 28, such that the movable energy storage device 20 can output alternating current through the inverter 28 for charging the energy storage type charging piles SP. With the arrangement of the energy storage type charging piles SP, there is still no need to additionally arrange electric wires, thereby solving the problem of difficulty in wiring and high cost of installing charging equipment in parking area. Moreover, the movable energy storage device 20 can also output direct current through the inverter 28, and therefore the movable energy storage device 20 can also directly provide electricity, as the manner in the abovementioned embodiment, for the electric vehicle EV in the parking space SP2 in which no energy storage type charging pile is disposed. Accordingly, there is no need to arrange an energy storage type charging pile SP in each parking space, just depending on the budget.

According to the charging system, the movable energy storage device, and the charging method discussed above, with the movable energy storage devices capable of transferring electricity between the charging station and the electric vehicle, the electric vehicle in the parking space can be charged without wiring to the charging station of the operation center. Moreover, the charging system, the movable energy storage device, and the charging method are adapted for electrically-powered vehicles regardless for transporting people or cargo or travelling by land, sea, or air.

Please be noted that the communication connection mentioned in the present disclosure refers to a connection manner that two components are able to exchange data with each other by, for example, wired or wireless transmission.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A charging system, configured to charge an electric vehicle, comprising:
a plurality of movable energy storage devices, wherein each of the plurality of movable energy storage devices comprises:
a carrier;
a dynamic balancer disposed on the carrier; and
at least one energy storage set comprising two flywheel energy storage modules disposed on the dynamic balancer and dynamically balanced with respect to the carrier through the dynamic balancer; and
an operation center comprising a charging station and a controller which is in communication connection with the plurality of movable energy storage devices;
wherein the controller is configured for instructing at least one of the plurality of movable energy storage devices to move to the charging station for the charging station to charge the at least one energy storage set, or the controller is configured for instructing at least one of the plurality of movable energy storage devices to move to the electric vehicle for the at least one energy storage set to charge the electric vehicle.

2. The charging system according to claim 1, wherein each of the two flywheel energy storage modules comprises a casing, a shaft, and a flywheel, the casing is disposed on the dynamic balancer, the shaft is disposed in the casing, the flywheel is disposed on the shaft and rotatable in the casing by taking the shaft as a rotation axis, the flywheels of the two flywheel energy storage modules have opposite rotation directions, substantially a same absolute value of angular velocity, and substantially a same absolute value of angular acceleration.

3. The charging system according to claim 2, wherein each of the plurality of movable energy storage devices further comprises:
at least one deflection wheel, located at a side of the carrier, wherein the carrier is movable with respect to the operation center through the at least one deflection wheel; and
at least one deflection assembly, connected to and located between the at least one deflection wheel and the casing of the at least one of the two flywheel energy storage modules;
wherein the dynamic balancer is pivotably disposed on the carrier, the casings of the two flywheel energy storage modules are pivotably disposed on the dynamic balancer, and a pivoting axis of the dynamic balancer with respect to the carrier is in non-parallel with each of pivoting axes of the casings of the two flywheel energy storage modules with respect to the dynamic balancer;
wherein a pivoting motion of the dynamic balancer with respect to the carrier drives the two flywheel energy storage modules to pivot with respect to the dynamic balancer, such that one of the two flywheel energy storage modules changes a travelling direction of the at least one deflection wheel through the at least one deflection assembly.

4. The charging system according to claim 3, wherein the at least one deflection assembly comprises a first deflection member and a second deflection member, the first deflection member is connected to the casing of one of the two flywheel energy storage modules and is rotatably connected to the dynamic balancer, the second deflection member is rotatably disposed on the carrier, the at least one deflection wheel is rotatably disposed on the second deflection member, and a rotation motion of the first deflection member with respect to the dynamic balancer selectively abuts on the second deflection member so as to change the travelling direction of the at least one deflection wheel through a rotation motion of the second deflection member.

5. The charging system according to claim 3, wherein each of the plurality of movable energy storage devices further comprises a handle coupled to the dynamic balancer so as to drive the pivoting motion of the dynamic balancer with respect to the carrier.

6. The charging system according to claim 5, wherein each of the plurality of movable energy storage devices further comprises a processing module, each of the plurality of movable energy storage devices is in communication connection with the controller through the processing module, the processing module transmits a current location and a current speed of the carrier to the controller every specific time period, the controller selectively transmits a deflection instruction to the processing module based on the current location and the current speed, and the handle is moved to drive the pivoting motion of the dynamic balancer with respect to the carrier after the processing module receives the deflection instruction.

7. The charging system according to claim 1, wherein the controller is configured to receive a charging request of the electric vehicle, and the charging request comprises a charging requirement of the electric vehicle; the controller sends a dispatch instruct comprising the charging requirement to the at least one of the plurality of movable energy storage devices based on the charging request so that the at least one of the plurality of movable energy storage devices moves to the electric vehicle to charge the electric vehicle.

8. The charging system according to claim 7, wherein the at least one of the plurality of movable energy storage devices compares a current capacity of the at least one energy storage set with the charging requirement of the dispatch instruct, and the at least one of the plurality of movable energy storage devices moves to the electric vehicle or send a charging request to the controller based on a comparison result.

9. The charging system according to claim 1, further comprising an energy storage type charging pile, wherein each of the plurality of movable energy storage devices further comprises an inverter;
wherein the at least one energy storage set of the at least one of the plurality of movable energy storage devices obtains electricity from the charging station;
the at least one energy storage set of the at least one of the plurality of movable energy storage devices provides electricity for the electric vehicle through the inverter; or
the at least one energy storage set of the at least one of the plurality of movable energy storage devices provides electricity for the electric vehicle through the inverter and the energy storage type charging pile.

10. A movable energy storage device, comprising:
a carrier;
a dynamic balancer disposed on the carrier; and
at least one energy storage set comprising two flywheel energy storage modules disposed on the dynamic balancer and dynamically balanced with respect to the carrier through the dynamic balancer.

11. The movable energy storage device according to claim 10, wherein each of the two flywheel energy storage modules comprises a casing, a shaft, and a flywheel, the casing is disposed on the dynamic balancer, the shaft is disposed in the casing, the flywheel is disposed on the shaft and rotatable in the casing by taking the shaft as a rotation axis, and the flywheels of the two flywheel energy storage modules have opposite rotation directions.

12. The movable energy storage device according to claim 11, further comprising:
at least one deflection wheel, located at a side of the carrier, wherein the carrier is movable through the at least one deflection wheel; and
at least one deflection assembly, connected to and located between the at least one deflection wheel and the casing of the at least one of the two flywheel energy storage modules;
wherein the dynamic balancer is pivotably disposed on the carrier, the casings of the two flywheel energy storage modules are pivotably disposed on the dynamic balancer, and a pivoting axis of the dynamic balancer with respect to the carrier is in non-parallel with each of pivoting axes of the casings of the two flywheel energy storage modules with respect to the dynamic balancer;
wherein a pivoting motion of the dynamic balancer with respect to the carrier drives the two flywheel energy storage modules to pivot with respect to the dynamic balancer, such that one of the two flywheel energy storage modules changes a travelling direction of the at least one deflection wheel through the at least one deflection assembly.

13. The movable energy storage device according to claim 12, wherein the at least one deflection assembly comprises a first deflection member and a second deflection member, the first deflection member is connected to the casing of one of the two flywheel energy storage modules and is rotatably connected to the dynamic balancer, the second deflection member is rotatably disposed on the carrier, the at least one deflection wheel is rotatably disposed on the second deflection member, and a rotation motion of the first deflection member with respect to the dynamic balancer selectively abuts on the second deflection member so as to change the travelling direction of the at least one deflection wheel through a rotation motion of the second deflection member.

14. The movable energy storage device according to claim 12, further comprising a handle coupled to the dynamic balancer so as to drive the pivoting motion of the dynamic balancer with respect to the carrier.

15. The movable energy storage device according to claim 14, further comprising a processing module, wherein the handle is moved to drive the pivoting motion of the dynamic balancer with respect to the carrier after the processing module receives a deflection instruction.

16. A charging method of an electric vehicle, comprising:
sending a charging request to a controller of an operation center by an electric vehicle, wherein the charging request comprises a charging requirement of the electric vehicle; and
sending a dispatch instruct to at least one movable energy storage device by the controller according to the charging request so that the at least one movable energy storage device moves to the electric vehicle and charges the electric vehicle, wherein the dispatch instruct comprises the charging requirement.

17. The charging method according to claim 16, wherein after sending the dispatch instruct to the at least one movable energy storage device by the controller, further comprising:
comparing the charging requirement of the dispatch instruct with a current capacity of at least one energy storage set of the at least one movable energy storage device by the at least one movable energy storage device; and
moving the at least one movable energy storage device to the electric vehicle or sending another charging request to the controller by the at least one movable energy storage device based on a comparison result.

18. The charging method according to claim 17, wherein after moving the at least one movable energy storage device to the electric vehicle based on the comparison result, further comprising:
moving the at least one movable energy storage device to a charging station of the operation center to obtain electricity after the electric vehicle is charged.

19. The charging method according to claim 17, wherein after sending the another charging request to the controller by the at least one movable energy storage device based on the comparison result, further comprising:
instructing the at least one movable energy storage device to move to a charging station of the operation center so as to obtain electricity by the controller; and
sending the dispatch instruct to another movable energy storage device by the controller.

20. The charging method according to claim 16, wherein the dispatch instruct further comprises a time point for charging, the at least one movable energy storage device moves to the electric vehicle and begins to charge the electric vehicle at the time point for charging, and the controller puts the at least one movable energy storage device on a charging schedule.
